(19) United States
(12) Patent Application Publication
(10) Pub. No.: US 2022/0123645 A1
(43) Pub. Date: Apr. 21, 2022

(54) INPUT DEVICE AND POWER GENERATION APPARATUS

(71) Applicant: Panasonic Intellectual Property Management Co., Ltd., Osaka (JP)

(72) Inventor: SUGURU OHISHI, Okayama (JP)

(21) Appl. No.: 17/607,020

(22) PCT Filed: Jun. 23, 2020
(86) PCT No.: PCT/JP2020/024530

§ 371 Date: Oct. 27, 2021

(30) Foreign Application Priority Data
Jul. 2, 2019 (JP) 2019-124066

(51) Int. Cl. H02K 35/02

(52) U.S. Cl. CPC H02K 35/02

(57) ABSTRACT

An input device includes: a fixed member; a movable member configured to move in a first direction relative to the fixed member; an operation element configured to move relative to the fixed member; and a spring member held on the movable member and configured to transmit force from the operation element to the movable member. The fixed member includes a first surface, the movable member includes a second surface, the fixed member and the movable member are in contact with each other on the first surface and the second surface, and one of the first surface and the second surface is a curved surface.

### TECHNICAL FIELD

The present disclosure generally relates to input devices and power generation apparatuses and more specifically relates to an input device and a power generation apparatus that produce an electrical output along with movement of a movable member.

### BACKGROUND ART

Conventionally, a power generation apparatus including a movable member that moves using a restoring force of a spring member is known (for example, refer to Patent Literature (PTL) 1).

The power generation apparatus disclosed in PTL 1 includes: an operation element (a push button); a movable member (a slider); two spring members (a first spring and a second spring); two permanent magnets (a first permanent magnet and a second permanent magnet); and a power generation unit. Without the operation element being operated, the movable member remains in a stable stopped state by the force of attraction of the permanent magnets. In this state, when the operation element is operated, the restoring force of one of the spring members (the first spring) causes the attraction of the permanent magnets to be cleared, causing the movable member to move rightward. When the operation of the operation element is cleared, the restoring force of the other of the spring members (the second spring) causes the attraction of the permanent magnets to be cleared, causing the movable member to move leftward.

In the power generation apparatus disclosed in PTL 1, as the movable member moves, the orientation of magnetic flux passing through a core (a first yoke member) of the power generation unit changes, and an electromotive force is generated in the coil provided on the outer periphery of the core.

### CITATION LIST

### Patent Literature

PTL 1: International Publication No. 2014-061225

### SUMMARY OF THE INVENTION

An input device according to one aspect of the present disclosure includes: a fixed member; a movable member capable of moving in a first direction relative to the fixed member; an operation element capable of moving relative to the fixed member; and a spring member held on the movable member and configured to transmit force from the operation element to the movable member, wherein the fixed member includes a first surface, the movable member includes a second surface, the fixed member and the movable member are in contact with each other on the first surface and the second surface, and one of the first surface and the second surface is a curved surface.

A power generation apparatus according to one aspect of the present disclosure includes: the above-described input device; and a power generation unit including a movable element and configured to convert kinetic energy of the movable element into electrical energy, the movable element being configured to operate in conjunction with the movable member.

### BRIEF DESCRIPTION OF THE DRAWINGS

FIG. 1 is a partial perspective view of a power generation apparatus (including an input device) according to one embodiment of the present disclosure as viewed from below.

FIG. 2A is a plan view illustrating the power generation apparatus with a movable member in a first position.

FIG. 2B is a cross-sectional view cut along line X1-X1 of FIG. 2A.

FIG. 3A is a plan view illustrating the power generation apparatus with the movable member in a second position.

FIG. 3B is a cross-sectional view cut along line X1-X1 of FIG. 3A.

FIG. 4 is a perspective view of the power generation apparatus as viewed from above.

FIG. 5 is an exploded perspective view of the power generation apparatus.

FIG. 6 is a perspective view of main parts of the power generation apparatus that illustrates a movable member, an operation element, and a spring member.

FIG. 7A is a perspective view illustrating one example of a surface of a movable member that faces a fixed member.

FIG. 7B is a perspective view illustrating one example of a surface of a movable member that faces a fixed member.

FIG. 7C is a perspective view illustrating one example of a surface of a movable member that faces a fixed member.

FIG. 8A is a perspective view illustrating a surface of a movable member that faces a fixed member according to a comparative example.

FIG. 8B is a cross-sectional view illustrating a surface of a movable member that faces a fixed member according to a comparative example.

FIG. 8C is a cross-sectional view illustrating one example of a surface of a movable member that faces a fixed member.

FIG. 8D is a cross-sectional view illustrating one example of a surface of a movable member that faces a fixed member.

FIG. 9 is a graph showing the result of durability tests in a working example, Reference Example 1, and Reference Example 2.

FIG. 10 is a perspective view illustrating another example of a fixed member.

FIG. 11 is a perspective view illustrating another example of a movable member.

FIG. 12 is a perspective view illustrating yet another example of a fixed member.

FIG. 13 is a perspective view illustrating yet another example of a movable member.

### DESCRIPTION OF EMBODIMENT

In the aforementioned power generation apparatus disclosed in PTL 1, as the movable member moves, the orientation of the magnetic flux passing through the core (the first yoke member) of the power generation unit changes, and an electromotive force is generated in the coil provided on the outer periphery of the core.

However, in a conventional power generation apparatus such as that mentioned above, as the number of times the movable member has moved increases, there is a higher likelihood of a phenomenon in which the timing of power generation varies. Specifically, there may be a difference between the timing of power generation at an initial stage at which the movable member has moved a small number of times and the timing of power generation at a later stage at which the movable member has moved a large number of times. Here, the timing of power generation refers in a broad sense to the timing at which an electrical output is produced.

Thus, the power generation apparatus (including the input device) according to the present disclosure makes it possible to reduce fluctuations in the timing at which an electrical output is produced.

### (1) Outline

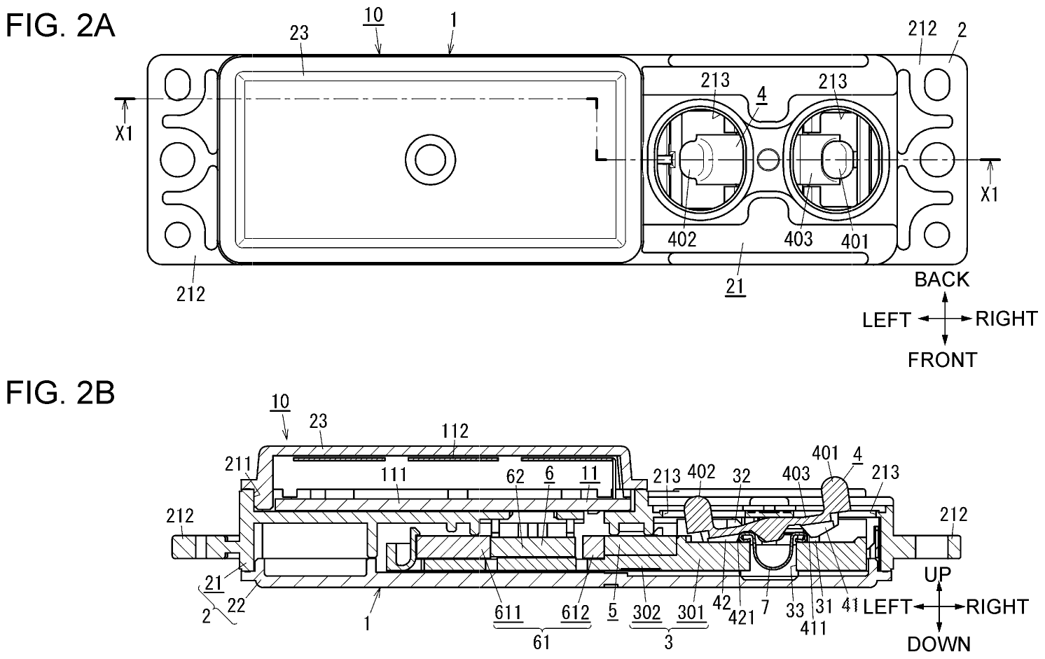

Power generation apparatus 10 according to the present exemplary embodiment includes input device 1 and power generation unit 6, as illustrated in FIG. 2A and FIG. 2B. Input device 1 includes fixed member 2, movable member 3, operation element 4, and spring member 7. Power generation apparatus 10 may further include permanent magnet 5.

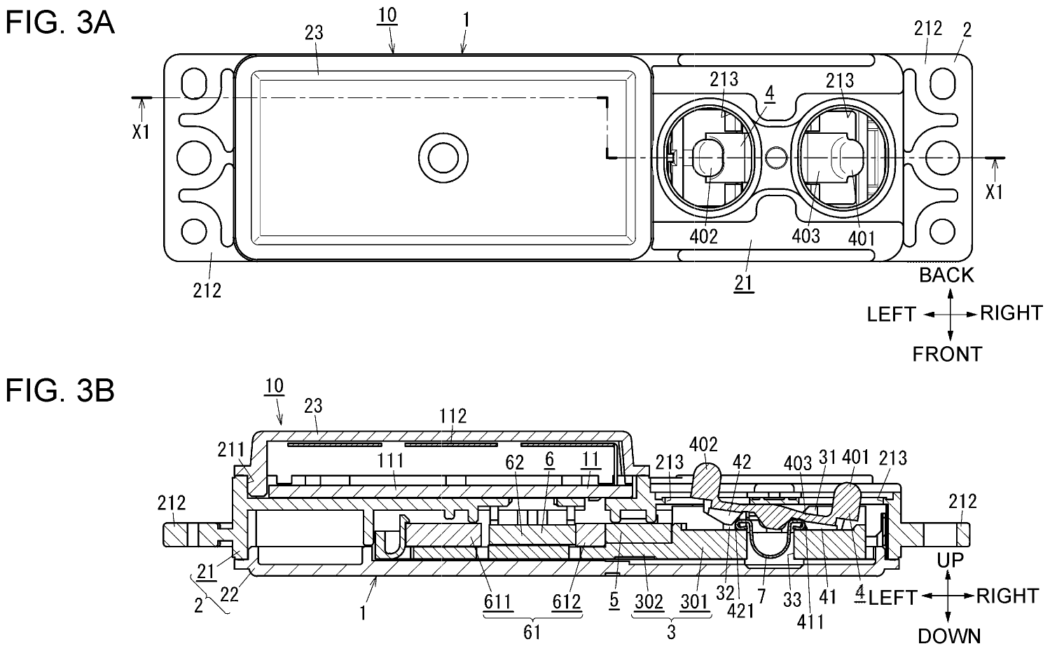

Power generation apparatus 10 can produce an electrical output as a result of movable member 3 moving in a predetermined direction (to the left and right in the example illustrated in FIG. 2A) with respect to fixed member 2. Movable member 3 moves between a first position (the position of movable member 3 illustrated in FIG. 2B) and a second position (the position of movable member 3 illustrated in FIG. 3B). Operation element 4 is configured to be movable relative to fixed member 2. Operation element 4 moves independently of movable member 3. In other words, movable member 3 and operation element 4 are both movable relative to fixed member 2, but movable member 3 and operation element 4, which are separate members independent of each other, can move individually.

Permanent magnet 5 exerts the force of attraction to hold movable member 3 in each of the first position and the second position. Power generation unit 6 includes movable element 61, which operates in conjunction with movable member 3, and converts kinetic energy of movable element 61 into electrical energy. Spring member 7 is held on movable member 3 and transmits, to movable member 3, force received from operation element 4.

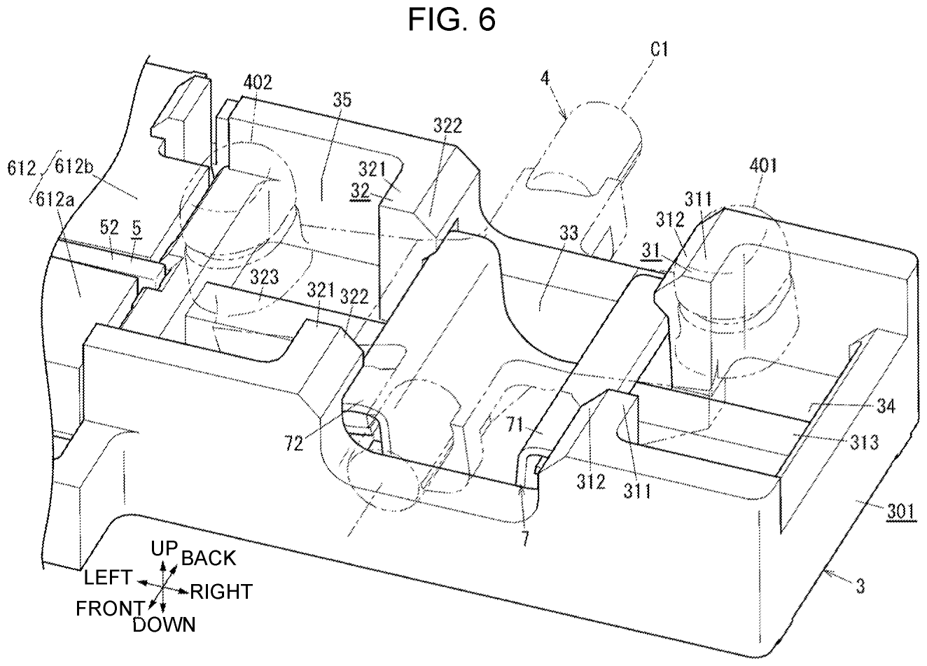

Here, movable member 3 includes: first holding portion 31 and second holding portion 32 (refer to FIG. 6) which are spaced apart in a predetermined direction, and first holding portion 31 is located near the first position and second holing unit 32 is located near the second position. Movable member 3 is configured to hold spring member 7 by sandwiching spring member 7 between first holding portion 31 and second holding portion 32.

Furthermore, movable member 3 has convex surface 391 as opposing surface 39 which faces fixed member 2.

Operation element 4 includes first pressing portion 41 and second pressing portion 42 which are spaced apart in the predetermined direction, and first pressing portion 41 is located near the first position and second pressing portion 42 is located near the second position. In the state where movable member 3 is in the first position, first pressing portion 41 is positioned so that spring member 7 is sandwiched between first pressing portion 41 and second holding portion 32. In the state where movable member 3 is in the second position, second pressing portion 42 is positioned so that spring member 7 is sandwiched between second pressing portion 42 and first holding portion 31.

Spring member 7 is configured such that when operation element 4 moves in a direction in which first pressing portion 41 approaches second holding portion 32 in the state where movable member 3 is in the first position, spring member 7 is compressed by first pressing portion 41 and second holding portion 32 and generates restoring force to move movable member 3 to the second position. Furthermore, spring member 7 is configured such that when operation element 4 moves in a direction in which second pressing portion 42 approaches first holding portion 31 in the state where movable member 3 is in the second position, spring member 7 is compressed by second pressing portion 42 and first holding portion 31 and generates restoring force to move movable member 3 to the first position.

Herein, the “predetermined direction” is a direction in which movable member 3 moves. In the present exemplary embodiment, movable member 3 moves in a straight line between the first position and the second position as one example. Therefore, the direction of the straight line connecting the first position and the second position is referred to as the “predetermined direction”.

The operation of power generation apparatus 10 configured as described above will be briefly described. Movable member 3 in the first position is held in place by the force of attraction of permanent magnet 5. When operation element 4, for example, is operated to move in this state, first pressing portion 41 is displaced toward second holding portion 32, and spring member 7 sandwiched between first pressing portion 41 and second holding portion 32 is compressed. At this time, spring member 7 is deformed, and thus energy is stored in spring member 7, allowing spring member 7 to generate restoring force. When the amount of displacement of first pressing portion 41 gradually increases and the restoring force of spring member 7 exceeds the force of attraction of permanent magnet 5, the holding of movable member 3 by permanent magnet 5 is undone, and the restoring force of spring member 7 causes movable member 3 to move from the first position to the second position.

Conversely, movable member 3 in the second position is held in place by the force of attraction of permanent magnet 5. When operation element 4, for example, is operated to move in this state, second pressing portion 42 is displaced toward first holding portion 31, and spring member 7 sandwiched between second pressing portion 42 and first holding portion 31 is compressed. At this time, spring member 7 is deformed, and thus energy is stored in spring member 7, allowing spring member 7 to generate restoring force. When the amount of displacement of second pressing portion 42 gradually increases and the restoring force of spring member 7 exceeds the force of attraction of permanent magnet 5, the holding of movable member 3 by permanent magnet 5 is undone, and the restoring force of spring member 7 causes movable member 3 to move from the second position to the first position.

Therefore, in power generation apparatus 10 according to the present exemplary embodiment, movable member 3 moves between the first position and the second position along with the operation (movement) of operation element 4, and thus power generation unit 6 converts kinetic energy of movable element 61, which operates in conjunction with movable member 3, into electrical energy. Furthermore, in power generation apparatus 10, a so-called fast-moving mechanism is used, and movable member 3 moves using the restoring force of spring member 7, meaning that movable member 3 moves at a relatively high speed regardless of the travel speed of operation element 4. Therefore, in power generation apparatus 10, the travel speed of movable member 3 is relatively stable, leading to a stable amount of power generation.

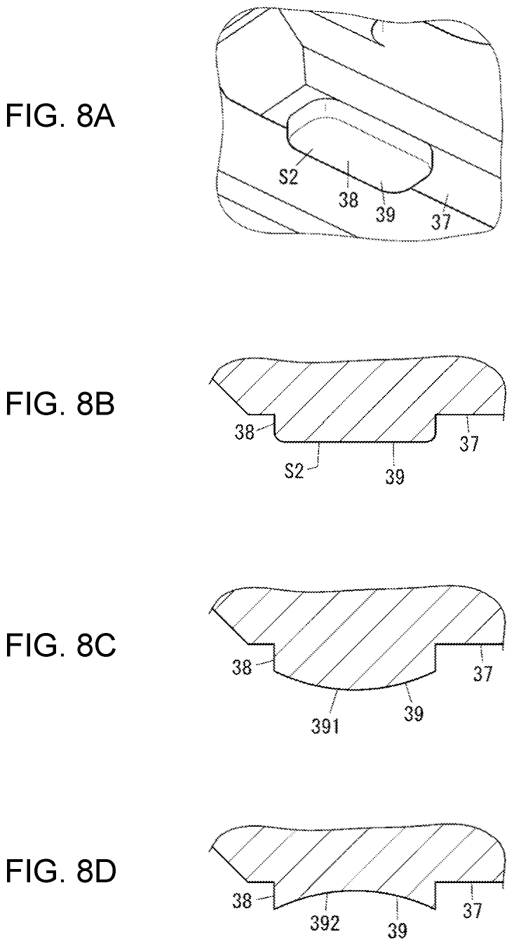

Furthermore, in power generation apparatus 10 according to the present exemplary embodiment, movable member 3 contacts fixed member 2 at opposing surface 39, which is convex surface 391 (refer to FIG. 8C), and thus the timing of power generation is less likely to vary even when the number of times movable member 3 has moved increases. This means a reduction in the difference between the timing of power generation at an initial stage at which movable member 3 has moved a small number of times and the timing of power generation at a later stage at which movable member 3 has moved a large number of times.

Power generation apparatus 10 according to the present exemplary embodiment may further include signal processing circuit 11. Signal processing circuit 11 is electrically connected to power generation unit 6 and outputs a signal using the electrical energy generated by power generation unit 6 in conjunction with operation element 4. In other words, signal processing circuit 11 can be operated with the electric power generated at power generation unit 6 along with the operation (movement) of operation element 4.

### (2) Details

Hereinafter, input device 1 and power generation apparatus 10 according to the present exemplary embodiment will be described with reference to the drawings. Note that the configuration described below is merely one example of the present disclosure and the present disclosure is not limited to the following exemplary embodiment. Therefore, as exemplary embodiments different from the present exemplary embodiment, various changes can be made according to the design, etc., within the technical scope according to the present disclosure

In the present exemplary embodiment, operation element 4 includes first button 401 and second button 402 which are spaced apart in the predetermined direction. Each of first button 401 and second button 402 can be pushed down in an operation direction. Herein, the “operation direction” is orthogonal to the “predetermined direction” in which movable member 3 moves. In the following description, the “predetermined direction” is the horizontal direction, and the “operation direction” is the vertical direction, unless otherwise particularly noted. More specifically, the orientation in which movable member 3 moves from the first position (refer to FIG. 2B) to the second position (refer to FIG. 3B) is leftward, and the orientation in which each of first button 401 and second button 402 is pressed down is downward. In other words, the upward, downward, leftward, and rightward directions are defined as indicated by the “UP”, “DOWN”, “LEFT”, and “RIGHT” arrows in FIG. 2B, etc. In the following description, a direction orthogonal to the drawing sheet of FIG. 2B is the depth direction and the near side is forward. In other words, the forward and backward directions are defined as indicated by the “FRONT” and “BACK” arrows in FIG. 2A, etc. Note that these directions are not intended to limit the direction in which power generation apparatus 10 shall be placed when in use. The arrows in the drawings that indicate directions are shown merely for the sake of explanation and are not substantive.

In the present exemplary embodiment, the “predetermined direction” and the “operation direction” are described as being orthogonal to each other. The wording “orthogonal” herein not only means crossing at a right angle in a strict sense, but also includes being substantially orthogonal within some margin of error (hereinafter, the wording “orthogonal” will be used in substantially the same sense).

### (2. 1) Input Device

First, input device 1 will be described with reference to the drawings.

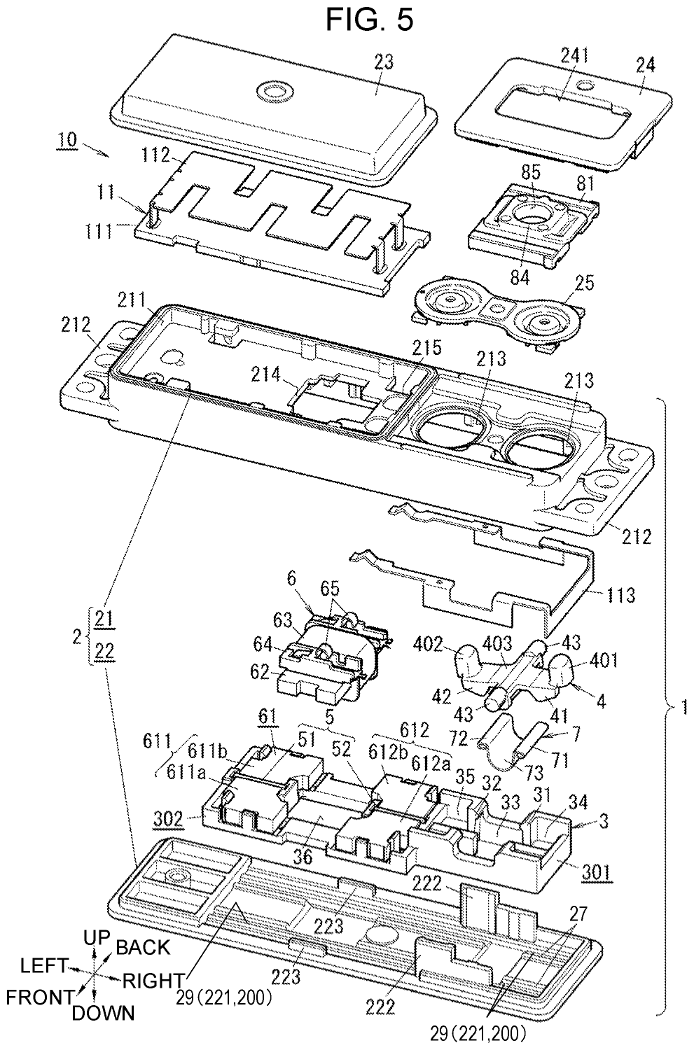

As illustrated in FIG. 5, input device 1 includes fixed member 2, movable member 3, operation element 4, and spring member 7. Furthermore, input device 1 may include covers (first cover 23 and second cover 24), waterproof rubber 25, and slide member 81.

### <Fixed Member>

Fixed member 2 is in the shape of a rectangular cuboid that is elongated in the horizontal direction and constitutes a housing in which movable member 3, operation element 4, spring member 7, and the like can be housed.

Fixed member 2 is made of synthetic resin. Fixed member 2 includes first case 21 and second case 22. First case 21 is formed in the shape of a box having a lower surface with an opening portion. Housing recess 211 is formed in first case 21. Housing recess 211 is formed in the upper surface of first case 21, to the left of a pair of through-holes 213. The bottom surface of housing recess 211 has first connection hole 214 and second connection hole 215 which penetrate said bottom surface vertically (refer to FIG. 5). Second case 22 is in the shape of a rectangular plate and is joined to first case 21 so as to cover the opening portion of first case 21. First case 21 and second case 22 are joined together in this manner by vertically fitting into each other and thus constitute fixed member 2. A pair of attachment pieces 212 for attaching fixed member 2 to an attachment target (not illustrated in the drawings) protrude respectively from both left and right end surfaces of first case 21. A pair of guide grooves 221 which extend in the horizontal direction are formed in the upper surface of second case 22 (refer to FIG. 5). Bottom surface 200 of guide groove 221 is flat.

First case 21 and second case 22 are joined together, for example, by laser welding. Thus, in input device 1, it is possible to keep water or the like from entering the space surrounded by first case 21 and second case 22 through the joint between first case 21 and second case 22.

The pair of through-holes 213, which are arranged in the horizontal direction, are formed on the upper surface of first case 21. Each of the pair of through-holes 213 has an opening in the shape of an ellipse that is long in the depth direction, and penetrates first case 21 vertically. The pair of through-holes 213 are holes through which operation element 4 is exposed on the upper surface of first case 21.

A pair of support walls 222 for supporting operation element 4 are formed on the upper surface of second case 22. The pair of support walls 222 face each other in the depth direction. Furthermore, a pair of ribs 223 are formed on the upper surface of second case 22. The pair of ribs 223 face each other in the depth direction.

### <Movable Member>

Movable member 3 is held on fixed member 2 in such a manner as to be able to horizontally move in a straight line. Movable member 3 moves between the first position (the position of movable member 3 illustrated in FIG. 2B) and the second position (the position of movable member 3 illustrated in FIG. 3B). In the present exemplary embodiment, since the direction of travel of movable member 3 moving from the first position to the second position is defined as the leftward direction, the second position is offset to the left of the first position, and the first position is offset to the right of the second position. This means that the right end position of the range of movement of movable member 3 is the first position and the left end position of the range of movement of movable member 3 is the second position. Therefore, the wording “near the first position” means “the right side” in the horizontal direction and the wording “near the second position” means “the left side” in the horizontal direction.

Specifically, movable member 3 is housed in the space surrounded by first case 21 and second case 22. Movable member 3 includes first block 301 and second block 302. First block 301 holds spring member 7. First block 301 and second block 302 are arranged side by side in the horizontal direction so that first block 301 is located to the right. The pair of support walls 222 are arranged on both front and back sides of first block 301. The pair of ribs 223 are arranged on both front and back sides of second block 302. In the present exemplary embodiment, movable member 3 is made of synthetic resin and is formed integrally with first block 301 and second block 302.

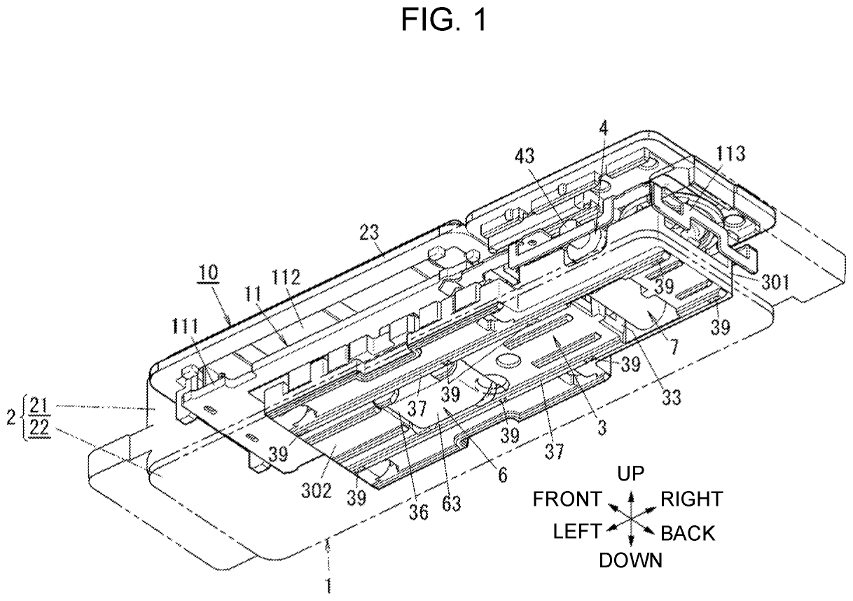

Movable member 3 is sandwiched between first case 21 and second case 22, and thus the movement of movable member 3 relative to fixed member 2 is restricted. A pair of guide protrusions 37 extending in the horizontal direction are formed on the lower surface of movable member 3 (refer to FIG. 1). The pair of guide protrusions 37 fit into the pair of guide grooves 221 of second case 22. Note that guide groove 221 is formed by guide protrusion 27 provided on second case 22 (refer to FIG. 5). The pair of guide protrusions 37 fitting into the pair of guide grooves 221 can move in the horizontal direction relative to the pair of guide grooves 221. The pair of guide protrusions 37 of movable member 3 fit into the pair of guide grooves 221 of fixed member 2, and thus the movement of movable member 3 relative to fixed member 2 in the depth direction is restricted. This allows movable member 3 to move relative to fixed member 2 in the horizontal direction only.

In the present embodiment, movable member 3 has opposing surface 39 which faces fixed member 2 (refer to FIG. 1). Specifically, there is more than one opposing surface 39 (in the present exemplary embodiment, four opposing surfaces 39 for each guide protrusion 37, specifically, a total of eight opposing surfaces 39) on the leading end surfaces (the lower surfaces) of the pair of guide protrusions 37 of movable member 3. The plurality of opposing surfaces 39 are spaced at approximately equal intervals on the leading end surface of each of the pair of guide protrusions 37.

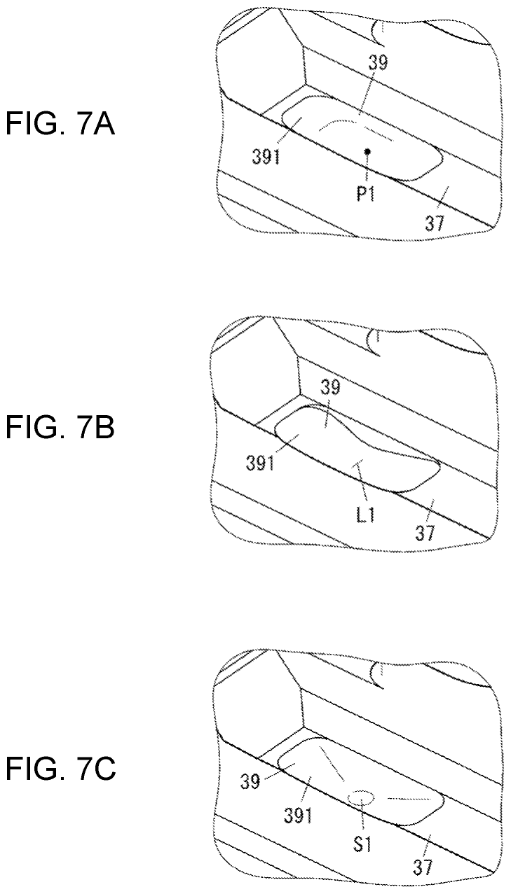

As illustrated in FIG. 7A, the plurality of opposing surfaces 39 are convex surfaces 391. Convex surface 391 is a curved surface projecting downward. This curved surface is curved in the horizontal direction and also curved in the depth direction. Thus, at the position of point P1, opposing surface 39 of movable member 3 and bottom surface 200 (opposing surface 29 in FIG. 5) of guide groove 221 of fixed member 2 easily come into point contact.

Furthermore, since opposing surface 39 illustrated in FIG. 7A does not include a flat surface, insufficient resin filling is less likely to occur at the time of mold shaping.

First block 301 has first opening portion 33 and is in the shape of a rectangular frame that is long in the horizontal direction as seen in plan view. Spring member 7 is housed in first opening portion 33. First recess 34 is formed to the right of first opening portion 33 in the upper surface of first block 301. Second recess 35 is formed to the left of first opening portion 33 in the upper surface of first block 301. First holding portion 31 is provided between first opening portion 33 and first recess 34 in first block 301. Second holding portion 32 is provided between first opening portion 33 and second recess 35 in first block 301. In other words, movable member 3 includes first holding portion 31 and second holding portion 32 which are spaced apart in the horizontal direction, and first holding portion 31 is located on the right side (near the first position) and second holding portion 32 is located on the left side (near the second position). In first block 301, spring member 7 is held in first opening portion 33 in such a manner that spring member 7 is sandwiched between first holding portion 31 and second holding portion 32.

Second block 302 has second opening portion 36 and is in the shape of a rectangular frame that is long in the horizontal direction as seen in plan view.

### <Operation Element>

Operation element 4 includes first button 401 and second button 402 which are spaced apart in the horizontal direction. In the state where operation element 4 is held so as to be movable relative to fixed member 2, first button 401 projects through right through-hole 213 out of the pair of through-holes 213, and second button 402 projects through left through-hole 213 out of the pair of through-holes 213. Operation element 4 is held on fixed member 2 in such a manner as to be rotatable between a first operation position (the position of operation element 4 illustrated in FIG. 2A and FIG. 2B) and a second operation position (the position of operation element 4 illustrated in FIG. 3A and FIG. 3B). In the present exemplary embodiment, operation element 4 is made of synthetic resin and is formed integrally with first button 401 and second button 402.

In the state where operation element 4 is in the first operation position, operation element 4 is tilting upward to the right relative to the upper surface of first case 21 so that first button 401 is positioned relatively higher than second button 402. In this state, when first button 401 is pressed down, operation element 4 rotates about rotation axis C1 (refer to FIG. 6) and moves to the second operation position. At this time, first button 401 moves downward, and second button 402 moves upward.

On the other hand, in the state where operation element 4 is in the second operation position, operation element 4 is tilting upward to the left relative to the upper surface of first case 21 so that second button 402 is positioned relatively higher than first button 401. In this state, when second button 402 is pressed down, operation element 4 rotates about rotation axis C1 and moves to the first operation position. At this time, second button 402 moves downward, and first button 401 moves upward. In other words, operation element 4 makes a seesaw movement between the first operation position and the second operation position by rotating about rotation axis C1 in both directions.

Operation element 4 is held on fixed member 2 in such a manner as to be rotatable about rotation axis C1 (refer to FIG. 6) between the first operation position and the second operation position. When first button 401 is pressed, operation element 4 rotates clockwise as viewed from the front, and when second button 402 is pressed, operation element 4 rotates counterclockwise as viewed from the front. Operation element 4 further includes: lever main body 403 in the shape of a rectangular plate as viewed in plan view; and a pair of shaft portions 43 formed in the shape of a circular cylinder. First button 401 and second button 402 project upward respectively from both left and right end portions of the upper surface of lever main body 403. At the lengthwise center of lever main body 403, the pair of shaft portions 43 project respectively from both front and back end surfaces of lever main body 403. Operation element 4 is held so as to be rotatable relative to fixed member 2 with first case 21 covering operation element 4 from above in the state where the pair of shaft portions 43 is placed on the pair of support walls 222 of second case 22. The movement of the pair of shaft portions 43 in the depth direction is restricted by a pair of bearing portions formed on the inner peripheral surface of first case 21.

Operation element 4 further includes first pressing portion 41 and second pressing portion 42 which are spaced apart in the horizontal direction, and first pressing portion 41 is located on the right side (near the first position) and second pressing portion 42 is located on the left side (near the second position). First pressing portion 41 and second pressing portion 42 project downward respectively from both left and right end portions of the lower surface of lever main body 403. Regarding the relationship between operation element 4 and movable member 3, first pressing portion 41 is disposed in a position corresponding to first recess 34 of first block 301, and second pressing portion 42 is disposed in a position corresponding to second recess 35 of first block 301. Regarding the relationship between operation element 4 and spring member 7, first pressing portion 41 and second pressing portion 42 are arranged on both left and right sides of spring member 7.

According to the configuration described above, spring member 7 is sandwiched between first pressing portion 41 and second holding portion 32 in the state where movable member 3 is in the first position. Spring member 7 is sandwiched between second pressing portion 42 and first holding portion 31 in the state where movable member 3 is in the second position. Therefore, as operation element 4 moves from the first operation position to the second operation position, first pressing portion 41 approaches second holding portion 32, and second pressing portion 42 moves away from first holding portion 31. At this time, spring member 7 is compressed by first pressing portion 41 and second holding portion 32. As operation element 4 moves from the second operation position to the first operation position, second pressing portion 42 approaches first holding portion 31, and first pressing portion 41 moves away from second holding portion 32. At this time, spring member 7 is compressed by second pressing portion 42 and first holding portion 31.

Therefore, when operation element 4 moves, the force of operation element 4 is transmitted to movable member 3 via spring member 7, causing movable member 3 to move. When operation element 4 moves from the first operation position to the second operation position, movable member 3 moves from the first position to the second position. When operation element 4 moves from the second operation position to the first operation position, movable member 3 moves from the second position to the first position.

### <Spring Member>

Spring member 7 is a component for transmitting force from operation element 4 to movable member 3 and is held on first block 301 of movable member 3. Specifically, when operation element 4 moves, spring member 7 is deformed (compressed) by receiving the force from operation element 4, and thus elastic energy is stored in spring member 7. Spring member 7 releases, toward movable member 3, the energy (elastic energy) stored by receiving the force from operation element 4, and thus transmits the force from operation element 4 to movable member 3.

Spring member 7 is formed of an elastic plate material such as sheet metal of stainless steel (SUS) or the like, for example. Specifically, in the present exemplary embodiment, spring member 7 is a leaf spring. Spring member 7 includes first end portion 71 and second end portion 72 respectively at both right and left ends. First end portion 71 is a right end portion of spring member 7, and second end portion 72 is a left end portion of spring member 7. Spring member 7 further includes, between first end portion 71 and second end portion 72, curved portion 73 which is curved so as to project in the thickness direction (the vertical direction) of spring member 7. Here, curved portion 73 is in a curved shape such as to project downward as viewed from the front. In the present exemplary embodiment, first end portion 71 and second end portion 72 are curled downward so as to form curved shapes that project to the right and left, respectively, as viewed from the front. Thus, spring member 7 is in the approximate “Ω” shape as viewed from the front.

### <Cover>

The cover includes first cover 23 and second cover 24. First cover 23 and second cover 24 are made of synthetic resin. First cover 23 and second cover 24 are arranged side by side in the horizontal direction. First cover 23 is located on the left side, and second cover 24 is located on the right side. First cover 23 is joined to first case 21 so as to cover the opening surface of housing recess 211. Second cover 24 is joined to first case 21 above the pair of through-holes 213. Guide hole 241 in the shape of a rectangle extending in the horizontal direction is formed at the center of second cover 24 so as to penetrate second cover 24 in the vertical direction. The cover and first case 21 are joined together, for example, by laser welding. Thus, it is possible to keep water or the like from entering housing recess 211 through the joint between first cover 23 and first case 21.

### <Waterproof Rubber>

Waterproof rubber 25 is fixed to the upper surface of first case 21, in an area around the pair of through-holes 213. Waterproof rubber 25 is flexible. Holes for passing first button 401 and second button 402 of operation element 4 are formed in waterproof rubber 25. Waterproof rubber 25 can fill the gap between the peripheral edge of each of the pair of through-holes 213 and a corresponding one of first button 401 and second button 402. Thus, it is possible to prevent the entry of water or the like through the pair of through-holes 213.

### <Slide Member 81>

Slide member 81 is held on fixed member 2 in such a manner as to be able to horizontally move in a straight line between a first slide position and a second slide position. Slide member 81 is in the first slide position when operation element 4 is in the first operation position, and is in the second slide position when operation element 4 is in the second operation position. Note that slide member 81 moves independently of movable member 3 and operation element 4. Specifically, all movable member 3, operation element 4, and slide member 81 are movable relative to fixed member 2, but movable member 3, operation element 4, and slide member 81 are separate members independent of each other and can move separately. Here, the first slide position is a left end position within the range of movement of slide member 81. The second slide position is a right end position within the range of movement of slide member 81. In the present exemplary embodiment, slide member 81 is held on first case 21 and second cover 24.

Slide member 81 includes operation protrusion 84. Operation protrusion 84 is located in guide hole 241 of second cover 24. Operation protrusion 84 is rectangular as seen in plan view. The length of operation protrusion 84 in the depth direction is approximately equal to the length of guide hole 241 in the depth direction. The length of operation protrusion 84 in the horizontal direction is less than the length of guide hole 241 in the horizontal direction.

In the present exemplary embodiment, in the rightward movement of slide member 81 from the first slide position to the second slide position when operation protrusion 84 is operated, slide member 81 pushes first button 401. Thus, operation element 4 rotates and moves from the first operation position to the second operation position. Therefore, first pressing portion 41 is displaced toward second holding portion 32, and the restoring force of spring member 7 causes movable member 3 to move from the first position to the second position.

Conversely, in the leftward movement of slide member 81 from the second slide position to the first slide position when operation protrusion 84 is operated, slide member 81 pushes second button 402. Thus, operation element 4 rotates and moves from the second operation position to the first operation position. Therefore, second pressing portion 42 is displaced toward first holding portion 31, and the restoring force of spring member 7 causes movable member 3 to move from the second position to the first position.

In this manner, at the time of the movement of slide member 81 between first slide position and the second slide position, operation element 4 is pushed by slide member 81 and operates in conjunction with slide member 81.

### (2. 2) Power Generation Apparatus

Power generation apparatus 10 includes input device 1 and power generation unit 6. Power generation apparatus 10 may further include permanent magnet 5, signal processing circuit 11, and ground wire 113.

### <Power Generation Unit>

Power generation unit 6 includes movable element 61, which operates in conjunction with movable member 3, and converts kinetic energy of movable element 61 into electrical energy. Movable element 61 is held on second block 302 of movable member 3. Power generation unit 6 includes, in addition to movable element 61, core 62 and coil 63 attached to core 62 (refer to FIG. 5). Coil 63 is housed in second opening portion 36 of second block 302 of movable member 3. In the present exemplary embodiment, power generation unit 6 further includes coil bobbin 64 and a pair of connection terminals 65.

Coil bobbin 64 is made of synthetic resin, and a wire wound around coil bobbin 64 constitutes coil 63. Core 62 is formed of a magnetic material such as a silicon steel plate, for example. Core 62 in the state of penetrating coil bobbin 64 in the depth direction is integrated with coil bobbin 64 and coil 63. The pair of connection terminals 65 are formed of electrically conductive metal plates. The pair of connection terminals 65 are held on coil bobbin 64 and are electrically connected respectively to both ends of the wire constituting coil 63.

Core 62 is fixed to fixed member 2. Here, core 62 is fixed to fixed member 2 in such a manner as to be pressed by first case 21 from above in the state where both front and back end portions of core 62 are placed on the pair of ribs 223 of second case 22. The movement of core 62 in the depth direction is restricted by a pair of restriction ribs formed on the inner peripheral surface of first case 21.

Movable element 61 is fixed to each of the left and right sides of second opening portion 36 in the upper surface of second block 302. Movable element 61 includes first movable piece 612 and second movable piece 612. First movable piece 611 and second movable piece 612 are located on both left and right sides of core 62.

First movable piece 611 is fixed on the left side of second opening portion 36 in the upper surface of second block 302. Second movable piece 612 is fixed on the right side of second opening portion 36 in the upper surface of second block 302. First movable piece 611 and second movable piece 612 are fixed to second block 302, for example, by a snap-fit structure using a coupling portion projecting from the upper surface of second block 302.

First movable piece 611 is divided in the depth direction as a pair of first yokes 611a, 611b. Second movable piece 612 is divided in the depth direction as a pair of second yokes 612a, 612b. The pair of first yokes 611a, 611b and the pair of second yokes 612a, 612b are each formed of a magnetic material such as a silicon steel plate, for example.

First movable piece 611 and second movable piece 612 are held on movable member 3, and thus movable element 61 operates in conjunction with movable member 3. Movement of movable member 3 causes movable element 61 to make relative movement with respect to core 62 fixed to fixed member 2. Here, regarding the relationship between movable member 3 and coil 63, coil 63 relatively moves in second opening portion 36 of movable member 3, and thus interference between movable member 3 and coil 63 is avoided. When movable element 61 moves, each of first movable piece 611 and second movable piece 612 connects to or disconnects from the front and back end portions of core 62.

Specifically, in the state where movable member 3 is in the first position (refer to FIG. 2A and FIG. 2B), first movable piece 611 contacts core 62. At this time, first yoke 611a contacts the front end portion of core 62, and first yoke 611b ontacts the back end portion of core 62. In this state, core 62 and second movable piece 612 are separated.

On the other hand, in the state where movable member 3 is in the second position (refer to FIG. 3A and FIG. 3B), second movable piece 612 contacts core 62. At this time, second yoke 612a contacts the front end portion of core 62, and second yoke 612b contacts the back end portion of core 62. In this state, core 62 and first movable piece 611 are separated.

### <Permanent Magnet>

Permanent magnet 5 includes first magnet 51 and second magnet 52. First magnet 51 is fixed to first movable piece 611, and second magnet 52 is fixed to second movable piece 612. Each of first magnet 51 and second magnet 52 is formed in the shape of a rectangular plate. First magnet 51 is sandwiched between the pair of first yokes 611a, 611b and fixed to first movable piece 611. Similarly, second magnet 52 is sandwiched between the pair of second yokes 612a, 612b and fixed to second movable piece 612. The polarities of first magnet 51 are set so that the front side thereof is the north pole and the back side thereof is the south pole. Therefore, first yoke 611a is magnetized as the north pole, and first yoke 611b is magnetized as the south pole. The polarities of second magnet 52 are set so that the front side thereof is the south pole and the back side thereof is the north pole. Therefore, second yoke 612a is magnetized as the south pole, and second yoke 612b is magnetized as the north pole.

Power generation unit 6 configured as described above generates electric power from coil 63 as a result of a change in the orientation of the magnetic flux passing through core 62 along with the movement of movable element 61.

Specifically, in the state where movable member 3 is in the first position, first movable piece 611 contacts core 62, and thus first yoke 611a, core 62, and first yoke 611b form a magnetic path through which the magnetic flux generated by first magnet 51 passes. Thus, the orientation of the magnetic flux passing through core 62 is backward (in the direction from the front end portion to the back end portion).

When movable member 3 moves from the first position to the second position, movable element 61 also moves in conjunction with movable member 3. Furthermore, in the state where movable member 3 is in the second position, second movable piece 612 contacts core 62, and thus second yoke 612b, core 62, and second yoke 612a form a magnetic path through which the magnetic flux generated by second magnet 52 passes. Thus, the orientation of the magnetic flux passing through core 62 is forward (in the direction from the back end portion to the front end portion). In other words, power generation unit 6 generates electric power by electromagnetic induction in which an induced current flows to coil 63 as a result of the magnetic field in coil 63 changing due to the movement of movable member 3.

Furthermore, in the present exemplary embodiment, permanent magnet 5 has not only a function for changing the orientation of the magnetic flux passing through core 62 as described above, but also a function for generating force of attraction to hold movable member 3 in each of the first position and the second position.

In other words, in the state where movable member 3 is in the first position, first movable piece 611 contacts core 62, thus first movable piece 611 adheres to core 62 by the magnetic flux generated by first magnet 51, and movable member 3 is held in the first position.

On the other hand, in the state where movable member 3 is in the second position, second movable piece 612 contacts core 62, thus second movable piece 612 adheres to core 62 by the magnetic flux generated by second magnet 52, and movable member 3 is held in the second position. In this manner, permanent magnet 5 to be used in the power generation at power generation unit 6 is also used as a permanent magnet for holding movable member 3 in each of the first position and the second position.

### <Signal Processing Circuit>

Signal processing circuit 11 is housed in housing recess 211 of first case 21. Signal processing circuit 11 includes printed board 111, antenna 112, and various electronic components. Various electronic components are mounted on printed board 111. The electronic components constitute a power supply circuit, a control circuit, memory, a transmission circuit, and the like, for example. Antenna 112 is mounted on the upper surface of printed board 111. Power generation unit 6 and a connection pad for electrically connecting ground wire 113 are provided on the lower surface of printed board 111. Signal processing circuit 11 is electrically connected to the pair of connection terminals 65 of power generation unit 6 through first connection hole 214 of first case 21.

Signal processing circuit 11 operates using, as a power supply, the electric power generated at power generation unit 6. Furthermore, signal processing circuit 11 uses, as an electrical signal, the electric power generated at power generation unit 6, and generates sensing information according to said electrical signal. Signal processing circuit 11 transmits the generated sensing information from antenna 112 to a reception device by wireless communication that uses radio waves as a transmission medium. The communication method used by signal processing circuit 11 is, for example, WiFi (registered trademark), Bluetooth (registered trademark), or the specified low power radio. The specified low power radio is low power radio that requires no license or registration; for example, in Japan, this is low power radio in which radio waves in the 420 MHz band or the 920 MHz band are used.

### <Ground Wire>

Ground wire 113 is formed of an electrically conductive metal plate. Ground wire 113 is disposed in the space formed between first case 21 and second case 22, around first block 301 along the inner peripheral surface of first case 21 in such a manner as not to interfere with movable member 3. Ground wire 113 is electrically connected to a circuit ground (reference potential point) of signal processing circuit 11 through second connection hole 215 of first case 21.

In power generation apparatus 10 configured as described above, movable member 3 moves along with the movement of operation element 4 relative to fixed member 2, and electric power is generated at power generation unit 6. The electrical signal output from power generation unit 6 when movable member 3 moves from the first position to the second position and the electrical signal output from power generation unit 6 when movable member 3 moves from the second position to the first position are different (for example, with different polarities). On the basis of the electrical signal output from power generation unit 6, signal processing circuit 11 generates sensing information corresponding to the direction of the movement of movable member 3 and transmits the sensing information to the reception device.

Therefore, in power generation apparatus 10 according to the present exemplary embodiment, when operation element 4 is operated, signal processing circuit 11 operates by receiving the electric power generated at power generation unit 6, and transmits the sensing information corresponding to the operation (movement) of operation element 4 to the reception device. At this time, the sensing information to be transmitted to the reception device varies according to the direction of the movement of movable member 3. In other words, operation element 4 is used as both an operation unit that causes power generation unit 6 to generate electric power and an operation unit that causes signal processing circuit 11 to transmit the sensing information. Thus, the number of components can be small as compared to a configuration in which the operation unit that causes signal processing circuit 11 to transmit the sensing information is provided separately from operation element 4 for use in power generation at power generation apparatus 10.

### (2. 3) Fast-Moving Mechanism

Next, the detailed configuration of movable member 3 (particularly, first block 301), spring member 7, and operation element 4 will be described with reference to FIG. 6. In FIG. 6, operation element 4 is shown by the imaginary lines (the chain double-dashed lines). Furthermore, in FIG. 6, rotation axis C1 of operation element 4 is shown by the chain line, but the illustration of rotation axis C1 is provided merely for the sake of explanation and is not substantive.

Movable member 3 holds spring member 7 by first holding portion 31 and second holding portion 32 which are arranged so as to face each other across first opening portion 33 in the horizontal direction. First holding portion 31 and second holding portion 32 are arranged so as to face each other across first opening portion 33 in the horizontal direction. Movable member 3 (first block 301) is configured to contact the four corners of spring member 7 as seen in plan view to hold spring member 7. Specifically, first holding portion 31 includes a pair of first holding pieces 311 which are spaced apart in the width direction orthogonal to the horizontal direction, and first holding portion 31 contacts first end portion 71 of spring member 7 from the right at the pair of first holding pieces 311. Similarly, second holding portion 32 includes a pair of second holding pieces 321 which are spaced apart in the width direction, and second holding portion 32 contacts the left side of second end portion 72 of spring member 7 at the pair of second holding pieces 321. Herein, the wording “the width direction” is orthogonal to both the predetermined direction (the horizontal direction) and the operation direction (the vertical direction); in the present exemplary embodiment, the width direction is the depth direction.

Furthermore, first holding portion 31 includes a pair of first protrusions 312 which project leftward from upper end portions of the left side surfaces of the pair of first holding pieces 311 which face second holding portion 32. The pair of first protrusions 312 are approximately triangular as seen from the front and contact first end portion 71 of spring member 7 from above. Similarly, second holding portion 32 includes a pair of second protrusions 322 which project rightward from upper end portions of the right side surfaces of the pair of second holding pieces 321 which face first holding portion 31. The pair of second protrusions 322 are approximately triangular as seen from the front and contact second end portion 72 of spring member 7 from above.

Furthermore, first holding portion 31 includes, between the pair of first holding pieces 311, first support base 313 which projects upward from the bottom surface of first recess 34. First support base 313 is spaced apart from the pair of first holding pieces 311 in the depth direction and contacts first end portion 71 of spring member 7 from below. Similarly, second holding portion 32 includes, between the pair of second holding pieces 321, second support base 323 which projects upward from the bottom surface of second recess 35. Second support base 323 is spaced apart from the pair of second holding pieces 321 in the depth direction and contacts second end portion 72 of spring member 7 from below.

With the above-described configuration, first holding portion 31 contacts first end portion 71 of spring member 7 from the right, above, and below, and thus the rightward, upward, and downward movement of first end portion 71 is restricted. Similarly, second holding portion 32 contacts second end portion 72 of spring member 7 from the left, above, and below, and thus the leftward, upward, and downward movement of second end portion 72 is restricted. Particularly, the horizontal movement of spring member 7 is restricted by the pair of first holding pieces 311 and the pair of second holding pieces 321 contacting the four corners of spring member 7 as seen in plan view.

Spring member 7 has first end portion 71 sandwiched between the pair of first protrusions 312 and first support base 313, and second end portion 72 sandwiched between the pair of second protrusions 322 and second support base 323; thus, spring member 7 is held on movable member 3 so as not to fall off.

The depth-wise dimension of lever main body 403 in operation element 4 is set smaller than the dimension between the pair of first holding pieces 311 and the dimension between the pair of second holding pieces 321. Thus, first pressing portion 41 is located between the pair of first holding pieces 311 in the depth direction. Second pressing portion 42 is located between the pair of second holding pieces 321 in the depth direction.

The positional relationship described above allows operation element 4 to contact first end portion 71 of spring member 7 from the right at first pressing portion 41 through the pair of first holding pieces 311, as illustrated in FIG. 6. Similarly, operation element 4 can contact second end portion 72 of spring member 7 from the left at second pressing portion 42 through the pair of second holding pieces 321. This means that operation element 4 compresses spring member 7 by contacting the depth-wise center of first end portion 71 of spring member 7 at first pressing portion 41 or contacting the depth-wise center of second end portion 72 of spring member 7 at second pressing portion 42. In other words, operation element 4 compresses spring member 7 by contacting the depth-wise center of spring member 7.

First pressing portion 41 includes, in a position opposite to second holding portion 32 in the horizontal direction, first inclined surface 411 which is tilted in the vertical direction so that the horizontal distance between first pressing portion 41 and second holding portion 32 changes along with the vertical movement (refer to FIG. 2A to FIG. 3B). In other words, the left end surface of first pressing portion 41 which is a surface contacting first end portion 71 of spring member 7 is first inclined surface 411 which is tilted downward to the left. Furthermore, second pressing portion 42 includes, in a position opposite to first holding portion 31 in the horizontal direction, second inclined surface 421 which is inclined in the vertical direction so that the horizontal distance between second pressing portion 42 and first holding portion 31 changes along with the vertical movement (refer to FIG. 2A to FIG. 3B). In other words, the right end surface of second pressing portion 42 which is a surface contacting second end portion 72 of spring member 7 is second inclined surface 421 which is tilted downward to the right. Herein, each of first pressing portion 41 and second pressing portion 42 is approximately triangular as viewed from the front.

In the above-described configuration, as a result of first pressing portion 41 moving downward in the movement of operation element 4 from the first operation position to the second operation position, the horizontal distance between first pressing portion 41 and second holding portion 32 is reduced because of first inclined surface 411. This means that first pressing portion 41 approaches second holding portion 32, downward force is converted into leftward force on first inclined surface 411, and spring member 7 is compressed. On the other hand, as a result of second pressing portion 42 moving upward in the movement of operation element 4 from the first operation position to the second operation position, the horizontal distance between second pressing portion 42 and first holding portion 31 is increased because of second inclined surface 421. In other words, second pressing portion 42 separates from first holding portion 31. Therefore, second pressing portion 42 is at a distance from second end portion 72 of spring member 7 in the state where spring member 7 is compressed; thus, it is possible to keep second pressing portion 42 from inhibiting the movement of second end portion 72 of spring member 7 at the time of release of the elastic energy of spring member 7.

The same holds true in the case where operation element 4 moves from the second operation position to the first operation position; as a result of second pressing portion 42 moving downward, the horizontal distance between second pressing portion 42 and first holding portion 31 is reduced because of second inclined surface 421. This means that second pressing portion 42 approaches first holding portion 31, downward force is converted into rightward force on second inclined surface 421, and spring member 7 is compressed. On the other hand, as a result of first pressing portion 41 moving upward in the movement of operation element 4 from the second operation position to the first operation position, the horizontal distance between first pressing portion 41 and second holding portion 32 is increased because of first inclined surface 411. Therefore, first pressing portion 41 is at a distance from first end portion 71 of spring member 7 in the state where spring member 7 is compressed; thus, it is possible to keep first pressing portion 41 from inhibiting the movement of first end portion 71 of spring member 7 at the time of release of the elastic energy of spring member 7.

### (2. 4) Operation

Hereinafter, the operation of power generation apparatus 10 according to the present exemplary embodiment will be described.

The following first describes the operation of power generation apparatus 10 performed when operation element 4 moves from the first operation position to the second operation position and movable member 3 moves from the first position to the second position.

In the case where movable member 3 is in the first position, operation element 4 that has not been operated is in the first operation position. In this state, spring member 7 is sandwiched between first pressing portion 41 and second holding portion 32 in the horizontal direction. First pressing portion 41 faces first end portion 71 of spring member 7, and second holding portion 32 faces second end portion 72 of spring member 7.

In this state, when first button 401 is pressed, operation element 4 rotates clockwise about rotation axis C1 as viewed from the front. In other words, first pressing portion 41 moves downward, and thus downward force is converted into leftward force by first inclined surface 411, displacing first end portion 71 of spring member 7 leftward. At this time, movable member 3 is held in the first position by the force of attraction generated by permanent magnet 5 (in this example, first magnet 51), and thus second holding portion 32 does not move. Therefore, in the horizontal direction, first pressing portion 41 approaches second holding portion 32, the distance between first end portion 71 and second end portion 72 of spring member 7 is reduced, and curved portion 73 is deformed so as to reduce the radius of curvature thereof. Thus, spring member 7 is compressed, and elastic energy is thereby stored in spring member 7, meaning that restoring force is generated at spring member 7.

In this state, when first button 401 is continuously pressed, operation element 4 further rotates clockwise about rotation axis C1 as viewed from the front. At this time, first pressing portion 41 moves further downward, and thus downward force is converted into leftward force by first inclined surface 411, displacing first end portion 71 of spring member 7 further leftward. When the amount of displacement of first end portion 71 increases, the amount of displacement of spring member 7 also increases, and thus the elastic energy stored in spring member 7 gradually increases. When the restoring force of spring member 7 exceeds the force of attraction of permanent magnet 5 (in this example, first magnet 51), the holding of movable member 3 by permanent magnet 5 is undone, and the elastic energy of spring member 7 is released. At this time, second end portion 72 of spring member 7 presses second holding portion 32, and thus the restoring force of spring member 7 causes movable member 3 to swiftly move leftward. As a result, movable member 3 moves to the second position (the position of movable member 3 illustrated in FIG. 3B), which is the terminal end position of the range of movement of movable member 3, at a relatively high speed. When movable member 3 moves from the first position to the second position, the kinetic energy of movable element 61 held on movable member 3 is converted into electrical energy, and electric power is generated at power generation unit 6.

The following describes the operation of power generation apparatus 10 performed when operation element 4 moves from the second operation position to the first operation position and movable member 3 moves from the second position to the first position.

In the case where movable member 3 is in the second position, operation element 4 that has not been operated is in the second operation position. In this state, spring member 7 is sandwiched between second pressing portion 42 and first holding portion 31 in the horizontal direction. Second pressing portion 42 faces second end portion 72 of spring member 7, and first holding portion 31 faces first end portion 71 of spring member 7.

In this state, when second button 402 is pressed, operation element 4 rotates counterclockwise about rotation axis C1 as viewed from the front. In other words, second pressing portion 42 moves downward, and thus downward force is converted into rightward force by second inclined surface 421, displacing second end portion 72 of spring member 7 rightward. At this time, movable member 3 is held in the second position by the force of attraction generated by permanent magnet 5 (in this example, second magnet 52), and thus first holding portion 31 does not move. Therefore, in the horizontal direction, second pressing portion 42 approaches first holding portion 31, the distance between first end portion 71 and second end portion 72 of spring member 7 is reduced, and curved portion 73 is deformed so as to reduce the radius of curvature thereof. Thus, spring member 7 is compressed, and elastic energy is thereby stored in spring member 7, meaning that restoring force is generated at spring member 7.

In this state, when second button 402 is continuously pressed, operation element 4 further rotates counterclockwise about rotation axis C1 as viewed from the front. At this time, second pressing portion 42 moves further downward, and thus downward force is converted into rightward force by second inclined surface 421, displacing second end portion 72 of spring member 7 further rightward. When the amount of displacement of second end portion 72 increases, the amount of displacement of spring member 7 also increases, and thus the elastic energy stored in spring member 7 gradually increases. When the restoring force of spring member 7 exceeds the force of attraction of permanent magnet 5 (in this example, second magnet 52), the holding of movable member 3 by permanent magnet 5 is undone, and the elastic energy of spring member 7 is released. At this time, first end portion 71 of spring member 7 presses first holding portion 31, and thus the restoring force of spring member 7 causes movable member 3 to swiftly move rightward. As a result, movable member 3 moves to the first position (the position of movable member 3 illustrated in FIG. 2B), which is the terminal end position of the range of movement of movable member 3, at a relatively high speed. When movable member 3 moves from the second position to the first position, the kinetic energy of movable element 61 held on movable member 3 is converted into electrical energy, and electric power is generated at power generation unit 6.

As described above, in power generation apparatus 10 according to the present exemplary embodiment, movable member 3 moves from the first position to the second position or movable member 3 moves from the second position to the first position along with the operation (movement) of operation element 4. In other words, movable member 3 horizontally reciprocates in a straight line between the first position and the second position. In both of the movement of movable member 3 from the first position to the second position and the movement of movable member 3 from the second position to the first position, movable member 3 moves at a relatively high speed due to the restoring force of spring member 7. Therefore, power generation unit 6 can generate electric power alike in both “the outward journey” in which movable member 3 moves from the first position to the second position and “the return journey” in which movable member 3 moves from the second position to the first position.

### (2. 5) Measures for Click Position Fluctuations

Next, measures for reducing fluctuations in the click position of power generation apparatus 10 (including input device 1) according to the present exemplary embodiment will be described. The “click position” herein is a position indicating ON in the force-displacement graph (F-S curve) (in other words, where force is removed) when operation element 4 is operated to move movable member 3 relative to fixed member 2. Specifically, this is the position of power generation apparatus 10 when power generation apparatus 10 generates electric power, that is, in a broad sense, where an electrical output is produced.

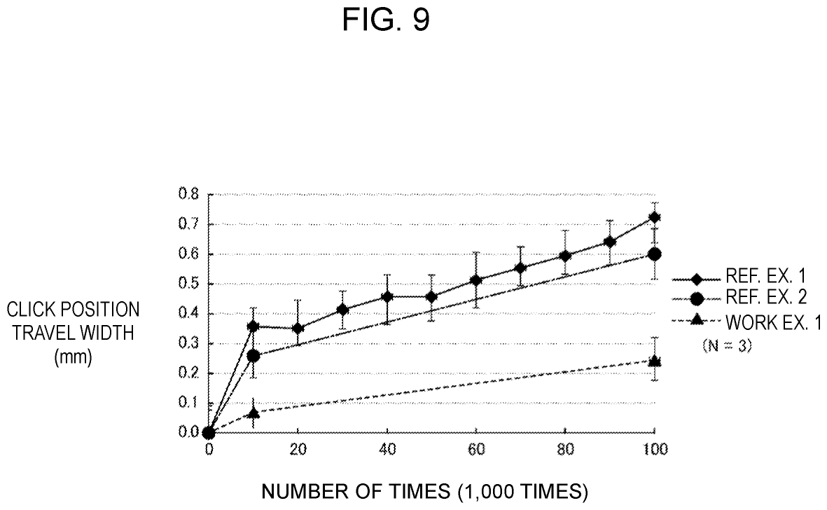

FIG. 9 is a graph showing the result of durability tests conducted on power generation apparatus 10 according to Working Example 1, Reference example 1, and Reference example 2. The horizontal axis represents the number of times movable member 3 has moved, and the vertical axis represents the click position travel width. The click position travel width represents a fluctuation width with respect to an initial click position.

Here, power generation apparatus 10 according to Working Example 1 is power generation apparatus 10 according to the exemplary embodiment described above. Specifically, movable member 3 includes opposing surface 39 illustrated in FIG. 7A.

Power generation apparatus 10 according to Reference Example 1 is substantially the same as power generation apparatus 10 according to the exemplary embodiment described above except that opposing surface 39 illustrated in FIG. 8A is included instead of opposing surface 39 illustrated in FIG. 7A. In power generation apparatus 10 according to Reference Example 1, there is more than one protruding part 38 (four protruding parts for each guide protrusions 37, specifically, a total of eight protruding parts 38) on the leading end surfaces (the lower surfaces) of the pair of guide protrusions 37 of movable member 3. The positions of the plurality of protruding parts 38 are the same as the positions of opposing surfaces 39 according to Working Example 1. Surface S2 which is the leading end surface (the lower surface) of each of protruding parts 38 is flat.

Power generation apparatus 10 according to Reference Example 2 is substantially the same as power generation apparatus 10 according to Reference Example 1 except that the mold is polished before molding of movable member 3. Note that the mold is not polished before molding of movable member 3 in the case of power generation apparatus 10 according to Reference Example 1.

As is clear in FIG. 9, in Reference Example 1, the click position has drastically changed through only 10,000 movements of movable member 3. In Reference Example 2, because of the mold polishing effects, the change in the click position is somewhat suppressed compared to Reference Example 1.

In contrast, in Working Example 1, it can be seen that even when movable member 3 has moved 10,000 times, the change in the click position is small. One cause of this result is presumably due to the fact that in Working Example 1, foreign matter (for example, wear debris) is less likely to be caught between fixed member 2 and movable member 3 than in Reference Examples 1, 2. Note that substantially the same trend can be seen in Working Example 1 and Reference Examples 1, 2 when the number of times movable member 3 has moved is between 10,000 and 100,000; this is considered to be due to wear of operation element 4. In other words, it is considered that the amount of compression of spring member 7 changes due to wear of operation element 4.

According to the estimation from Working Example 1, opposing surfaces 39 illustrated in FIG. 7B, FIG. 7C, FIG. 8C, and FIG. 8D can produce the advantageous effect to reduce the fluctuations in the click position.

Opposing surface 39 illustrated in FIG. 7B is a curved surface projecting downward; this curved surface is not curved in the depth direction, but is curved in the horizontal direction only. Thus, at the position of line L1, opposing surface 39 of movable member 3 and the bottom surface of guide groove 221 of fixed member 2 easily come into line contact. Line L1 extends in the depth direction.

Opposing surface 39 illustrated in FIG. 7C is a curved surface projecting downward to form the shape of a truncated cone. Thus, at the position of face S1 which is the leading end surface (the lower surface) in opposing surface 39, opposing surface 39 of movable member 3 and the bottom surface of guide groove 221 of fixed member 2 easily come into face contact. Face S1 is flat.

Opposing surface 39 illustrated in FIG. 8C is formed by changing, into convex surface 391, the leading end surface of protruding part 38 illustrated in FIG. 8A. Thus, as in Working Example 1, opposing surface 39 of movable member 3 and the bottom surface of guide groove 221 of fixed member 2 easily come into point contact.

Opposing surface 39 illustrated in FIG. 8D is formed by changing, into concave surface 392, the leading end surface of protruding part 38 illustrated in FIG. 8A. Thus, at portion 393 on a leading edge of protruding part 38, opposing surface 39 of movable member 3 and bottom surface 200 of guide groove 221 of fixed member 2 (refer to FIG. 5) easily come into line contact. Note that there are cases where bottom surface 200 of guide groove 221 is denoted as opposing surface 29 (the first surface).

As described above, in power generation apparatus 10 according to the present exemplary embodiment, the timing of power generation is less likely to fluctuate even when the number of times movable member 3 has moved increases by about 100,000. Specifically, the difference is slight between the timing of power generation at an initial stage at which movable member 3 has moved a small number of times and the timing of power generation at a later stage at which movable member 3 has moved a large number of times. In a broad sense, with input device 1 according to the present exemplary embodiment, it is possible to reduce fluctuations in the timing at which an electrical output is produced.

### (2. 6) Application Example

As one example, power generation apparatus 10 is used as a crescent sensor which senses locking/unlocking of a crescent key. In this case, power generation apparatus 10 is mounted on an attachment target, i.e., a window frame, so that operation element 4 is indirectly operated by way of the crescent key. In power generation apparatus 10, the operation status of operation element 4 changes depending on whether the crescent key is in the locked state or the unlocked state. Therefore, in a reception device that receives sensing information from power generation apparatus 10, it is possible to monitor whether the crescent key is in the locked state or the unlocked state.

### (3) Variations

Variations of the above-described exemplary embodiment will be listed below.

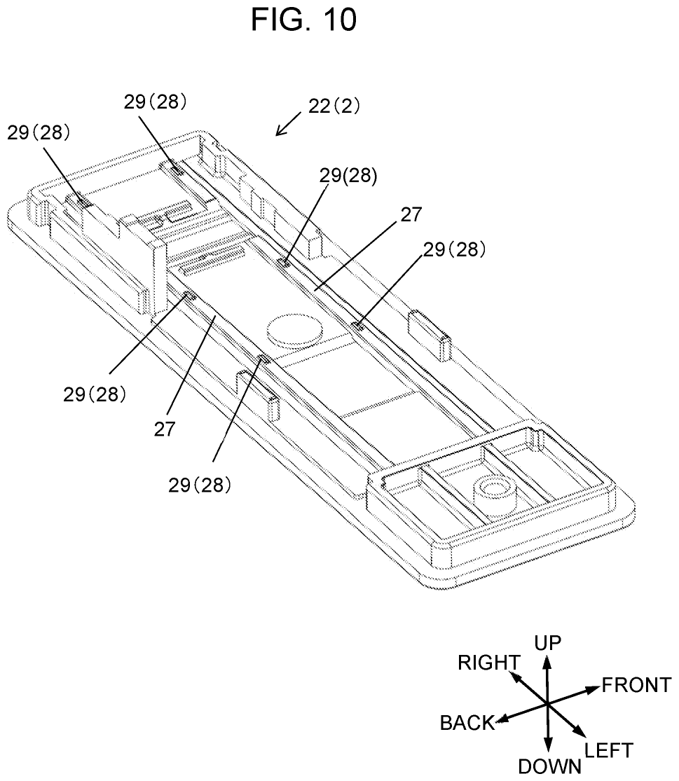

In the above-described exemplary embodiment, opposing surface 39 of movable member 3 which faces fixed member 2 is convex surface 391, but opposing surface 29 of fixed member 2 which faces movable member 3 may be a convex surface. Furthermore, opposing surface 39 of movable member 3 which faces fixed member 2 may be concave surface 392 (refer to FIG. 8D). Opposing surface 29 of fixed member 2 which faces movable member 3 may be a concave surface (refer to FIG. 10).

Furthermore, it is sufficient that operation element 4 include first pressing portion 41 and second pressing portion 42 which are spaced apart in the predetermined direction; first pressing portion 41 and second pressing portion 42 are not limited to being integrated and may be separate. In other words, first pressing portion 41 and second pressing portion 42 may be integrally formed of one member or first pressing portion 41 and second pressing portion 42 may be formed of different members and be individually movable.

Furthermore, power generation apparatus 10 is not limited to being configured to be used to detect the position of a mechanical component (a crescent key) like a crescent sensor; for example, power generation apparatus 10 may be configured so as to be operated by a person as a switch for operating a device. In this case, power generation apparatus 10 may be configured so that operation element 4 is directly operated by a person or may be configured so that operation element 4 is indirectly operated by a person via an operation handle or the like.

Furthermore, in power generation apparatus 10, a switch for transmitting sensing information to signal processing circuit 11 may be provided separately from power generation unit 6. In this case, signal processing circuit 11 generates a sensing signal according to ON/OFF of the switch using, as a power supply, the electric power generated at power generation unit 6. In this case, the switch may turn ON/OFF in conjunction with operation element 4 or an operation unit that operates the switch may be provided separately from operation element 4 of power generation apparatus 10.

Furthermore, the communication method used between signal processing circuit 11 and the reception device is not limited to the wireless communication that uses radio waves as a transmission medium, and may be, for example, wired communication or optical wireless communication in which light such as infrared rays is used as a medium.

Furthermore, in power generation apparatus 10, it is sufficient that the same restoring force of spring member 7 be used in the movement of movable member 3 from the first position to the second position and the movement of movable member 3 from the second position to the first position; the feature in which spring member 7 is a single member is not essential to power generation apparatus 10. For example, a plurality of spring members 7 may be provided in series or in parallel between operation element 4 and movable member 3. Even in such a case, the same restoring force of the plurality of spring members 7 is used in the movement of movable member 3 from the first position to the second position and the movement of movable member 3 from the second position to the first position.

Furthermore, spring member 7 is not limited to the configuration described in the above exemplary embodiment; for example, spring member 7 may be such that first end portion 71 and second end portion 72 are not curled. Moreover, spring member 7 is not limited to a leaf spring and may be a compression coil spring or a torsion spring, for example.

Furthermore, in power generation unit 6, core 62 and coil 63 may be provided on the movable element 61 side, and permanent magnet 5 may be provided on the fixed element (in other words, a member fixed to fixed member 2) side. Even in this configuration, permanent magnet 5 makes relative movement with respect to core 62, and thus the movement of movable element 61 allows for a change in the orientation of the magnetic flux passing through core 62.

Furthermore, operation element 4 is not limited to being exposed on the upper surface of fixed member 2 and may be exposed on a side surface or the lower surface of fixed member 2. In the case where operation element 4 is provided on a side surface of fixed member 2, operation element 4 may move in a straight line between the first operation position and the second operation position in the predetermined direction. In other words, operation element 4 is not limited to the seesaw structure and may be a direct-acting push button structure or slide structure, for example.

Furthermore, it is sufficient that movable element 61 of power generation unit 6 operate in conjunction with movable member 3; movable element 61 is not limited to being fixed to movable member 3. For example, movable element 61 may be a part of movable member 3 or may be connected to movable member 3 via a link.

Furthermore, power generation apparatus 10 may be configured so that electric power is generated at power generation unit 6 in only one of the movement of movable member 3 from the first position to the second position and the movement of movable member 3 from the second position to the first position.

Furthermore, operation element 4 is not limited to including two buttons (first button 401 and second button 402) as in the above-described exemplary embodiment, but may include three or more buttons. Alternatively, operation element 4 may include only one button.

Furthermore, input device 1 is not limited to being used in power generation apparatus 10; stand-alone input device 1 may be incorporated and used in tools, equipment, and the like other than power generation apparatus 10.

Furthermore, power generation apparatus 10 is not limited to the configuration in which signal processing circuit 11 is housed in first cover 23 as in the above-described exemplary embodiment; signal processing circuit 11 may be provided partially or entirely outside first cover 23. The electronic components included in signal processing circuit 11 are not limited to the power supply circuit, the control circuit, the memory, the communication circuit, and the like and, for example, may be a sensor, an AD converter, a DA converter, a reception circuit, and the like.

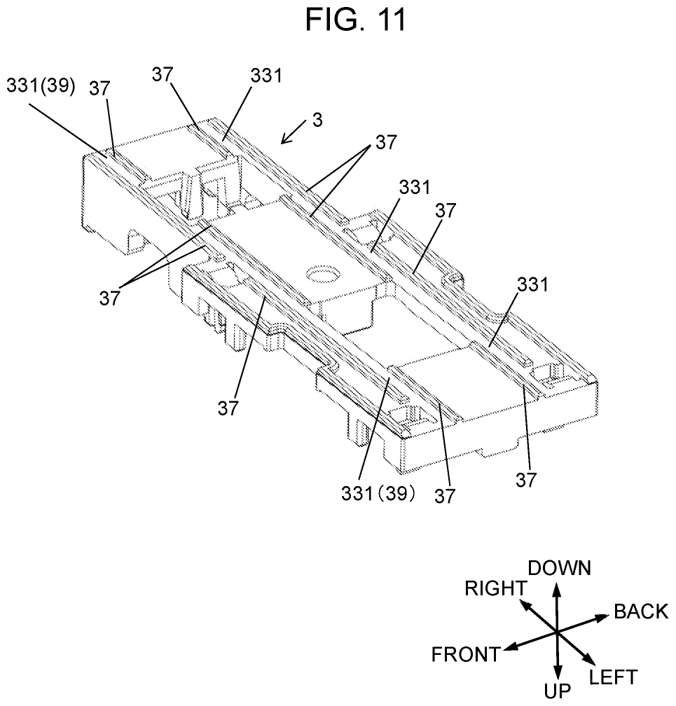

Note that in the above-described exemplary embodiment, opposing surface 39 is provided on the lower surface of movable member 3 as illustrated in FIG. 1, but opposing surface 29 may be provided on fixed member 2 (second case 22) as illustrated in FIG. 10. In FIG. 10, opposing surface 29 is provided on protruding part 28. In the case where fixed member 2 has the configuration illustrated in FIG. 10, it is preferred that guide groove 331 be provided in movable member 3 as illustrated in FIG. 11. In FIG. 11, two guide protrusions 37 form guide groove 331. Note that guide protrusion 37 is partially split, and a part of guide grooves 331 is formed using only one guide protrusion 37.

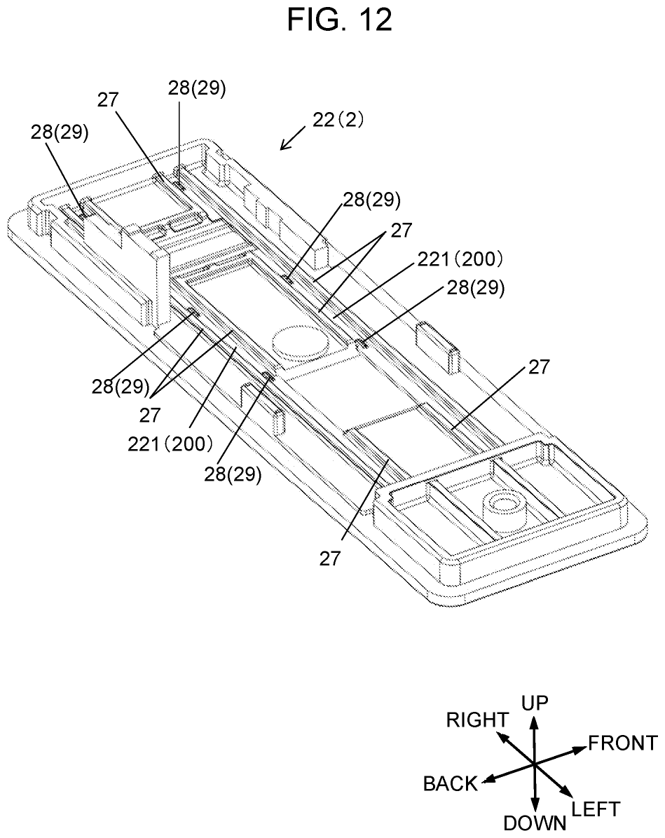

Note that in the above-described exemplary embodiment, protruding part 38 (opposing surface 39) is provided on guide protrusion 37, but protruding part 28 (opposing surface 29) may be provided on bottom surface 200 of guide groove 221 as illustrated in FIG. 12. In FIG. 12, two guide protrusions 27 form guide groove 221. Note that guide protrusion 27 is partially split, and a part of guide grooves 221 is formed using only one guide protrusion 27.

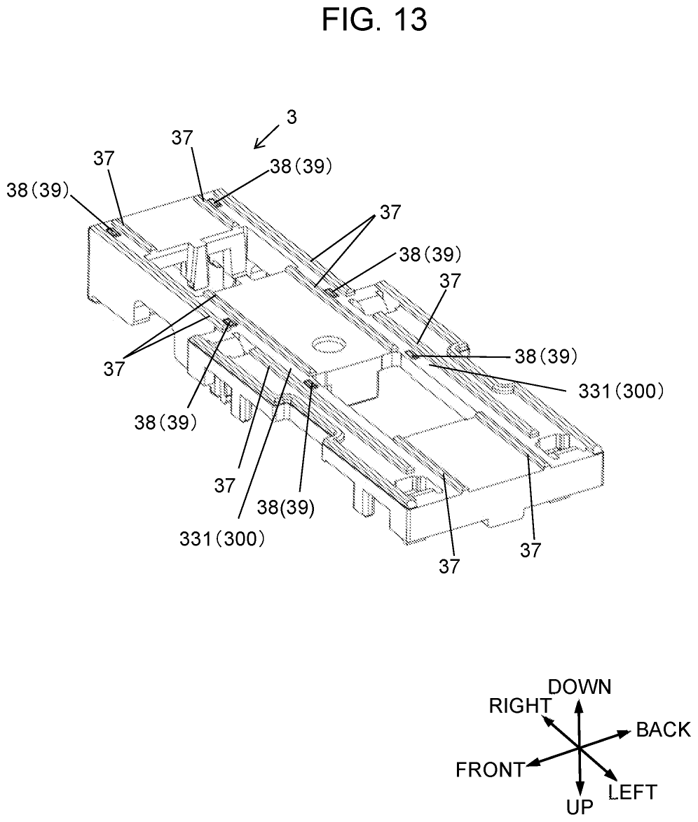

Furthermore, protruding part 38 (opposing surface 39) may be provided on bottom surface 300 of guide groove 331 of movable member 3 as illustrated in FIG. 13. As in FIG. 11, two guide protrusions 37 form guide groove 331 in FIG. 13. Note that guide protrusion 37 is partially split, and a part of guide grooves 331 is formed using only one guide protrusion 37. In the case where movable member 3 has the configuration illustrated in FIG. 13, guide protrusion 27 is provided on fixed member 2 and serves as opposing surface 29.

### (4) Conclusion

As is clear from the above-described exemplary embodiment, the present disclosure includes the following aspects.

Input device 1 according to one aspect of the present disclosure includes: fixed member 2; movable member 3 configured to move in in a first direction (the horizontal direction) relative to fixed member 2; operation element 4 configured to move relative to fixed member 2; and spring member 7 held on movable member 3 and configured to transmit force from operation element 4 to movable member 3, wherein fixed member 2 includes a first surface (opposing surface 29), movable member 3 includes a second surface (opposing surface 39), and fixed member 2 and movable member 3 are in contact with each other on the first surface (opposing surface 29) and the second surface (opposing surface 39), and one of the first surface (opposing surface 29) and the second surface (opposing surface 39) is a curved surface.

According to this aspect, by reducing, for example, the effect of foreign matter being caught between fixed member 2 and movable member 3, it is possible to reduce fluctuations in the timing at which electrical output is produced.

In input device 1 according to another aspect of the present disclosure, one of the first surface (opposing surface 29) and the second surface (opposing surface 39) is a convex surface.

According to this aspect, the frictional force between fixed member 2 and movable member 3 is easily reduced.

For example, as illustrated in FIG. 7A, in input device 1 according to another aspect of the present disclosure, fixed member 2 and movable member 3 are in point contact on the first surface (opposing surface 29) and the second surface (opposing surface 39).

According to this aspect, fixed member 2 and movable member 3 easily come into point contact.

For example, as illustrated in FIG. 8D, in input device 1 according to another aspect of the present disclosure, one of the first surface (opposing surface 29) and the second surface (opposing surface 39) is a concave surface.

According to this aspect, fixed member 2 and movable member 3 easily come into line contact.

For example, as illustrated in FIG. 10 or FIG. 12, in input device 1 according to another aspect of the present disclosure, fixed member 2 further includes protruding part 28, and protruding part 28 includes the first surface (opposing surface 29).

According to this aspect, it is possible to reduce fluctuations in the timing at which an electrical output is produced.

For example, as illustrated in FIG. 10 and FIG. 11, in input device 1 according to another aspect of the present disclosure, movable member 3 includes guide groove 331 extending in the first direction (the horizontal direction), fixed member 2 includes guide protrusion 27 configured to fit in guide groove 331, and protruding part 28 is provided on guide protrusion 27 of fixed member 2.

According to another aspect, by causing guide protrusion 27 to fit in guide groove 331, the movement of movable member 3 relative to fixed member 2 is easily restricted in the predetermined direction.

For example, as illustrated in FIG. 12, in input device 1 according to another aspect of the present disclosure, fixed member 2 includes guide groove 221 extending in the first direction (the horizontal direction), movable member 3 includes guide protrusion 37 configured to fit in guide groove 221, and protruding part 28 is provided on bottom surface 200 of guide groove 221 of fixed member 2.

According to another aspect, by causing guide protrusion 37 to fit in guide groove 221, the movement of movable member 3 relative to fixed member 2 is easily restricted in the predetermined direction.

In input device 1 according to another aspect of the present disclosure, fixed member 2 includes a plurality of protruding parts 28.

According to this aspect, it is possible to reduce the deflection of fixed member 2.

For example, as illustrated in FIG. 1 and FIG. 13, in input device 1 according to another aspect of the present disclosure, movable member 3 further includes protruding part 38, and protruding part 38 includes the second surface (opposing surface 39).

According to this aspect, it is possible to reduce fluctuations in the timing at which an electrical output is produced.

For example, as illustrated in FIG. 13, in input device 1 according to another aspect of the present disclosure, movable member 3 includes guide groove 331 extending in the first direction (the horizontal direction), fixed member 2 includes guide protrusion 27 configured to fit in guide groove 331, and protruding part 38 is provided on bottom surface 300 of guide groove 331 of movable member 3.

According to another aspect, by causing guide protrusion 27 to fit in guide groove 331, the movement of movable member 3 relative to fixed member 2 is easily restricted in the predetermined direction.

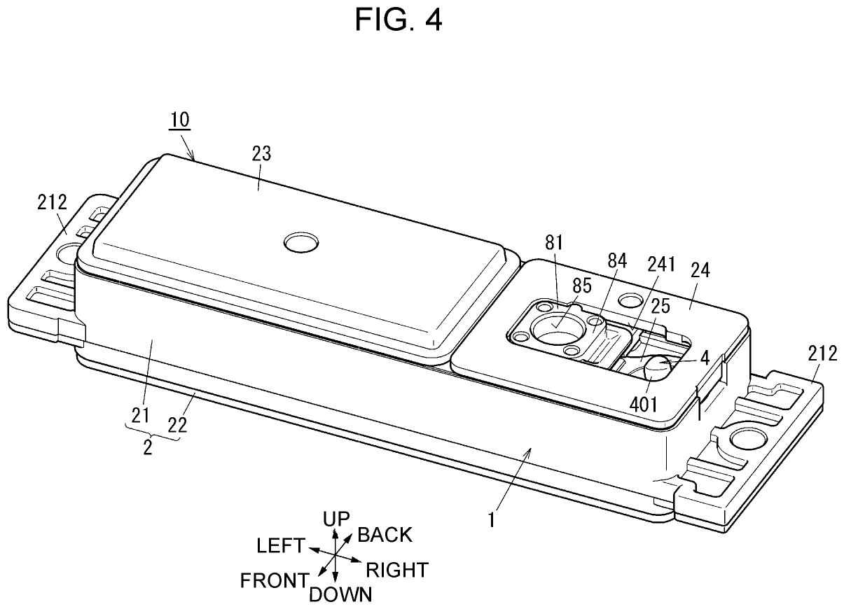

For example, as illustrated in FIG. 1 to FIG. 5, in input device 1 according to another aspect of the present disclosure, fixed member 2 includes guide groove 221 extending in the first direction (the horizontal direction), movable member 3 includes guide protrusion 37 configured to fit in guide groove 221, and protruding part 38 is provided on guide protrusion 37 of movable member 3.

According to another aspect, by causing guide protrusion 37 to fit in guide groove 221, the movement of movable member 3 relative to fixed member 2 is easily restricted in the predetermined direction.

In input device 1 according to another aspect of the present disclosure, movable member 3 includes a plurality of protruding parts 38.

According to this aspect, it is possible to reduce the deflection of movable member 3.

Power generation apparatus 10 according to one aspect of the present disclosure includes: input device 1 described above; and power generation unit 6 including movable element 61, which operates in conjunction with movable member 3, and configured to convert kinetic energy of movable element 61 into electrical energy.

According to this aspect, by reducing, for example, the effect of foreign matter being caught between fixed member 2 and movable member 3, fluctuations in the timing at which electrical output is produced can be reduced in power generation apparatus 10.

### REFERENCE MARKS IN THE DRAWINGS

1 input device

2 fixed member

21 first case

22 second case

221 guide groove

27 guide protrusion

28 protruding part

29 opposing surface (first surface)

3 movable member

331 guide groove

37 guide protrusion

38 opposing surface (second surface)

391 convex surface

392 concave surface

4 operation element

6 power generation unit

61 movable element

7 spring member

10 power generation apparatus

200 bottom surface

300 bottom surface

1. An input device, comprising:
a fixed member;
a movable member configured to move in a first direction relative to the fixed member;
an operation element configured to move relative to the fixed member; and
a spring member held on the movable member and configured to transmit force from the operation element to the movable member, wherein
the fixed member includes a first surface,
the movable member includes a second surface,
the fixed member and the movable member are in contact with each other on the first surface and the second surface, and
one of the first surface and the second surface is a curved surface.

2. The input device according to claim 1, wherein
the curved surface is a convex surface.

3. The input device according to claim 1, wherein
the fixed member and the movable member are in point contact on the first surface and the second surface.

4. The input device according to claim 1, wherein
the curved surface is a concave surface.

5. The input device according to claim 1, wherein
the fixed member further includes a protruding part, and
the protruding part includes the first surface.

6. The input device according to claim 5, wherein
the movable member includes a guide groove extending in the first direction,
the fixed member includes a guide protrusion configured to fit in the guide groove, and
the protruding part is provided on the guide protrusion of the fixed member.

7. The input device according to claim 5, wherein
the fixed member includes a guide groove extending in the first direction,
the movable member includes a guide protrusion configured to fit in the guide groove, and
the protruding part is provided on a bottom surface of the guide groove of the fixed member.

8. The input device according to claim 5, wherein
the fixed member includes a plurality of protruding parts each being the protruding part.

9. The input device according to claim 1, wherein
the movable member further includes a protruding part, and
the protruding part includes the second surface.

10. The input device according to claim 9, wherein
the movable member includes a guide groove extending in the first direction,
the fixed member includes a guide protrusion configured to fit in the guide groove, and
the protruding part is provided on a bottom surface of the guide groove of the movable member.

11. The input device according to claim 9, wherein
the fixed member includes a guide groove extending in the first direction,
the movable member includes a guide protrusion configured to fit in the guide groove, and
the protruding part is provided on the guide protrusion of the movable member.

12. The input device according to claim 9, wherein
the movable member includes a plurality of protruding parts each being the protruding part.

13. A power generation apparatus, comprising:
the input device according to claim 1; and
a power generation unit including a movable element and configured to convert kinetic energy of the movable element into electrical energy, the movable element being configured to operate in conjunction with the movable member.
